(19) United States
(12) Patent Application Publication
(10) Pub. No.: US 2022/0268521 A1
(43) Pub. Date: Aug. 25, 2022

(54) FURNACE ROLLER AND ROLLER FURNACE

(71) Applicant: BENTELER MASCHINENBAU GMBH, Bielefeld (DE)

(72) Inventors: Radovan KOUT, Liberec (CZ); Dvorak BOREK, Jablonec nad Nisou (CZ); Daniel SIDA, Semily (CZ)

(21) Appl. No.: 17/680,028

(22) Filed: Feb. 24, 2022

(30) Foreign Application Priority Data
Feb. 25, 2021 (DE) 10 2021 104 560.6

(51) Int. Cl. F27D 3/02; F27B 9/24

(52) U.S. Cl. CPC F27D 3/026; F27B 9/2407

(57) ABSTRACT

The present disclosure relates to a furnace roller and to a roller furnace having such a furnace roller. The furnace roller has a hollow-cylindrical roller body with an interior space. A stopper is arranged in each end-side length portion of the roller body. The stopper is composed of a geopolymer, such as an alkali-activated aluminosilicate.

### RELATED APPLICATIONS

The present application claims priority of German Application Number 10 2021 104 560.6 filed Feb. 25, 2021, the disclosure of which is hereby incorporated by reference herein in its entirety.

### FIELD

The present disclosure relates to a furnace roller and to a roller furnace having such a furnace roller.

### BACKGROUND

During the continuous heat treatment of metal sheets, continuous furnaces are used in concatenated production processes. The prevailing type of heat treatment plant for press-hardening processes is the roller furnace, which is suitable both for the indirect and for the direct press-hardening process, and is distinguished by high process reliability and plant availability. In addition to the furnace chamber and the heating technology, the so-called roller table, also referred to as roller bed, is a component of the roller furnace. Depending on the furnace length, roller diameter and roller distance, a multiplicity of rotating furnace rollers form a continuous conveyor. The furnace rollers pass in this case through the insulation of the furnace towards the outside, are there mounted by bearings and driven.

Furnace rollers are available in ceramic or metallic embodiments. Furnace rollers are commonly made of steel, silicon carbide (SiC), quartz or mullite. Plasma-coated steel rollers are also used. Here, a steel roller is coated with ceramic, for example, aluminum oxide or zinc oxide.

For high-temperature applications such as press-hardening processes, the use of metallic rollers is subject to material-related limitations or operation has to be performed with a complex water cooling system inside the rollers. Therefore, ceramic furnace rollers have become established in high-temperature applications above 1000° C. Ceramic furnace rollers are distinguished by high strength at high temperatures.

DE 10 2010 029 082 A1 describes a continuous furnace, wherein the temperatures in the inlet region of the continuous furnace are intended to be between 1200° C. and 1400° C. Therefore, in the inlet region, use is made of furnace rollers which are formed from a ceramic material and which should have a higher thermal resistance and a higher strength than the material from which the furnace rollers in the holding region of the continuous furnace are formed.

DE 10 2017 114 165 A1 describes a roller for a roller furnace having a roller base body and a coating on the surface. The roller base body is a hollow tube with a cavity and is able to be composed of a ceramic material from the group of mullite, alumina, SiC or mixtures thereof. On the end side, both ends of the roller base body have a tapering for fastening of a drive sleeve.

EP 2 703 759 A1 describes a load-bearing means in the form of furnace rollers, which are intended to be used in heat treatment plants for aluminum/silicon (AlSi)-coated metal parts. The furnace roller has a core with a coating on the outer surface. The core is able to be composed of a metallic or ceramic material.

DE 10 2016 116 869 B4 describes a furnace roller comprising a central part, composed of a multi-layered tube, and end-side bearing journals. The bearing journals are able to be welded to the central part by means of an intermediate piece, wherein a stopper-like insulating material is introduced in the intermediate piece.

### SUMMARY

The present disclosure is based on providing a furnace roller that is improved for operational use, with an increased service life, better insulation properties, such as higher thermal shock resistance, and of specifying a roller furnace that is improved in terms of operation and energy.

According to the present disclosure, this object is solved by a furnace roller.

A furnace roller for a roller furnace has a hollow-cylindrical roller body with an interior space. A stopper is arranged in each end-side length portion of the roller body. According to the present disclosure, the stopper is composed of a geopolymer.

The geopolymer is an alkali-activated aluminosilicate.

Geopolymers are materials which are synthetically produced from predominantly inorganic raw materials in a multi-stage process. They have good physical properties and permit environmentally friendly production. Geopolymers are able to be produced, inter alia, from thermally activated waste materials or secondary raw materials. Examples of waste products or secondary raw materials are able to be blast furnace slag, fly ash, ground brick or melting chamber sand.

Fire is not required to form their ceramic structure since they are cold-hardening. The latter property allows for the production of a furnace roller according to the present disclosure, since the geopolymer material is liquid in the initial phase and thus is able to be cast into a furnace roller of any desired length and diameter and hardens there at predefinable positions. Here, means for positioning the stopper are used.

The stopper composed of geopolymer has a high chemical, thermal and also a biological resistance. The stopper experiences only a small amount of shrinkage during the drying operation. The material has a low thermal conductivity with high stability. The material is initially flowable or is a castable composition which hardens relatively rapidly with very good binding properties.

As a result of the stopper composed of geopolymer provided in the region of the end-side length portions, internal insulation is effected in the region of the transition between the furnace chamber and the external environment separated by the side wall of the furnace. This reduces the transmission or dissipation of heat from the furnace interior space and from the interior space of the furnace roller. The furnace roller has improved insulating properties and a significantly increased thermal shock resistance and is able to readily compensate for process-related temperature changes. Roller fractures are able to be reduced. Consequently, the service lives of the furnace rollers and thus the plant availability are improved and the operating costs reduced. Heat losses are reduced and the energy intensity of the furnace operation is reduced.

The insulation of the interior space provided according to the present disclosure, by the stopper which delimits the interior space in the end-side length portions of the roller body, thermally insulates or shields and protects the region of the bearing arrangement of the furnace rollers.

A geopolymer that is in the context of the present disclosure is composed of an aluminosilicate activated by alkali, SiO2 and Al2O3 with a production-related residue. The aluminosilicate geopolymer is an inorganic polymer which is formed at high pH values by polycondensation. During its formation, aluminum and silicon oxides are alkali activated. This is able to be effected by sodium or potassium hydroxide. Due to the cleaving of the Si—O bonds, a three-dimensional structure forms inside the furnace roller. A geopolymer is fundamentally composed of an aluminosilicate and an activator component.

The solid aluminosilicate component used is able to be natural or synthetic aluminosilicates or kaolin as well as ground granulated blast furnace slag, microsilica, ground trass, oil shale, fly ash, blast furnace slag, aluminum-containing silica dust, pozzolan, basalt as well as clays or soils, kieselguhr, zeolites and ground brick or melting chamber sand, and mixtures of same.

Alkaline activator components are present in an aqueous solution or in the form of a suspension. Examples of alkaline activator components are able to be sodium water glass, potassium water glass, as well as lithium water glass or ammonium water glass, soda hydroxide, sodium hydroxide solution, potassium hydroxide, sodium carbonate, potassium carbonate, alkali metal sulfate, sodium metasilicate, potassium metasilicate, milk of lime, or mixtures of the aforementioned components.

The geopolymers used in accordance with the present disclosure are distinguished by high thermal resistance as well as high chemical resistance and has the mechanical properties necessary for the intended use in high-temperature applications in the roller furnace. A reduction in weight of a furnace roller since the hollow-cylindrical roller body is hollow on the inside over the predominant part of its length is able to be achieved, and is a hollow roller having the stoppers composed of geopolymer positioned on the inner side, the length portions with the stoppers being effected in the region where the furnace rollers are guided through the lateral furnace walls or the side walls of the furnace chamber.

The insulating properties as well as the desired gas permeability of the stoppers and also the binding properties to the inner wall of the tube body are able to be improved through the addition of additives and/or aggregates, for example, foam additives.

At least one embodiment of the present disclosure provides that the stopper has a length L_{S} and the roller body has an inner diameter Dᵢ, wherein the ratio of the inner diameter Dᵢ to the length L_{S} of the stopper is between 4:1 and 2:1.

The ratio of the inner diameter Dᵢ to the length L_{S} of the stopper is between 3.25:1 and 2.25:1.

At least one embodiment of the present disclosure provides that, in the case of an inner diameter of the roller body of 65 mm, the dimensions of the stopper are in each case between 20 mm and 25 mm, inclusive.

The furnace roller has a hollow-cylindrical roller body with a hollow interior space which has, on both sides, that is to say to the left and right, a stopper composed of geopolymer in an end-side length portion directed towards the roller end.

At least one embodiment of the present disclosure provides that the stoppers delimit the interior space of the roller body to the left and right and are arranged at a distance from the end face of the roller body. This allows the furnace rollers to be insulated in the region of the transition between the furnace chamber and the external environment separated by the side wall of the furnace. In this way, the external bearing arrangement of the furnace roller and mechanical clamping elements are able to be protected from impermissible heat or temperature effects and are able to be safeguarded against damage. In addition, a very good insulating action is effected by the sealing of the interior space, so that an escape of heat is prevented and thus the energy intensity of the furnace operation is reduced.

The stoppers insulate and seal the interior space of the roller body, the stoppers being permeable to gas. The stopper composed of geopolymer and the inner diameter of the roller body are connected by chemical bond. Owing to the gas permeability of the stoppers, pressure compensation is able to be performed.

The stopper composed of geopolymer has a fiber-free structure. The roller body and the stopper are composed of materials which are classified in the same category of waste. The roller body is composed of a ceramic material. Separate disposal of damaged furnace rollers is not necessary. The roller body and the stopper do not need to be disposed of separately since they are able to be assigned to the same category of waste or are classified under the same waste classification in accordance with the European list of waste (German List of Wastes Ordinance, AVV).

The roller body is able to have an outer coating or a sheath.

A roller furnace according to the present disclosure has a furnace chamber and side walls which delimit the furnace chamber, and also a furnace roller according to the present disclosure. The roller furnace has a roller bed formed from a multiplicity of furnace rollers according to the present disclosure.

The end-side length portions of the furnace roller are guided in each case by an outer side wall. According to the present disclosure, the stopper is arranged in the region of a side wall. The stopper is located in a length portion at the transition of the furnace chamber to the side wall.

The roller furnace is improved in terms of energy. A reduction in the operating costs and increased plant availability are to be expected. Owing to the high strength and the improved thermal shock resistance of the rollers, there is the possibility of using smaller roller diameters to increase the usable furnace chamber width and height, which has the result that the roller furnace process also becomes more economical.

### BRIEF DESCRIPTION OF THE DRAWINGS

The present disclosure is described to an extent below with reference to drawings, in which:

FIG. 1 shows a perspective view of a furnace module of a roller furnace according to the present disclosure;

FIG. 2 shows a longitudinal section of a furnace roller according to the present disclosure, and

FIG. 3 shows a detail of the side wall of a roller furnace in the region where a furnace roller is guided through towards the outside according to the present disclosure.

### DETAILED DESCRIPTION

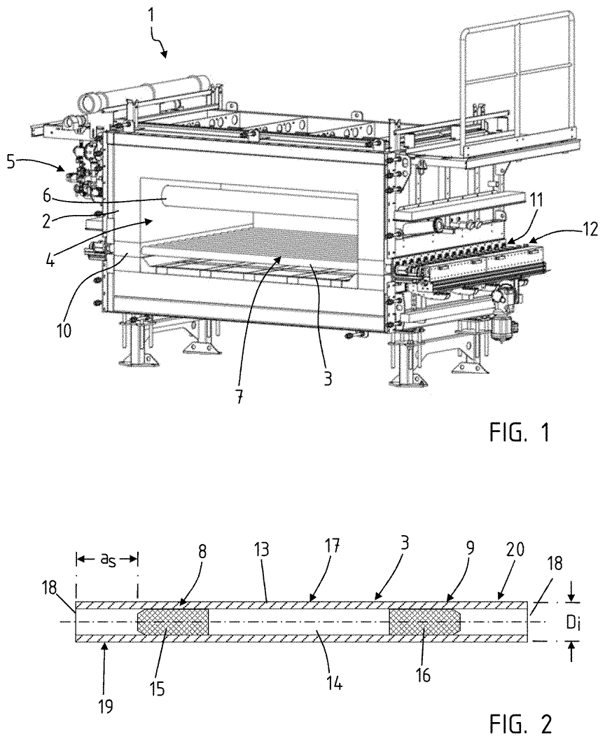

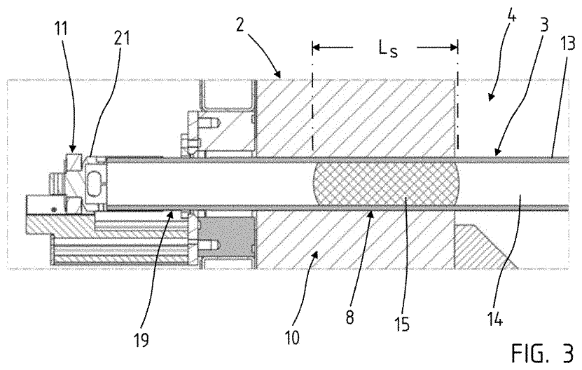

FIG. 1 shows a furnace module of a roller furnace 1 according to the present disclosure. FIG. 3 illustrates a detail of a side wall 2 of the roller furnace 1 in the region where a furnace roller 3 is guided through towards the outside.

The roller furnace 1 is typically composed of multiple furnace modules which are connected in a row in succession and has a run-in zone (not illustrated here) and a furnace chamber 4 which, in cross section, is delimited on all sides by furnace walls, and a run-out zone (likewise not illustrated here) where the heated products, for example metal sheets, exit the roller furnace 1 after the heat treatment. The heating is effected via a heating system 5 and burners 6. The products to be heated are transported on a roller bed 7 formed by furnace rollers 3. The furnace rollers 3 extend over the furnace chamber width and are guided through the side walls 2 of the furnace chamber 4 towards the outside. Here, on the left and right of the furnace chamber 4, the furnace rollers 3 pass through an insulating and load-bearing portion 10 of the side walls 2 in each case by way of an end-side length portion 8, 9. On the outside, the furnace rollers 3 are held in a bearing arrangement 11 and are able to be driven by means of a drive system 12 which is not described in any more detail.

FIG. 2 shows a furnace roller 3 in longitudinal cross section.

The furnace roller 3 has a roller body 13 composed of a ceramic material with an interior space 14. The interior space 14 is delimited on both sides by a respective stopper 15, 16. The tube body 13 is able to have an outer coating or a sheath on its outer circumference.

The interior space 14 extends over the central length portion 17 of a furnace roller 3. The stoppers 15, 16 are arranged in each case in an end-side length portion 8, 9 of the roller body 13 and fill the inner diameter Dᵢ of the roller body 13.

The stoppers 15, 16 are composed of a geopolymer composed of an alkali-activated aluminosilicate. For the production, a raw material mixture is formed, of a solid having aluminosilicates and an activator component which is added in the form of an aqueous solution or a suspension.

Mixing and homogenizing of the mixture or of the composition produces a settable, doughy or slurry-like, castable substance and initiates polycondensation of the alkali metal-aluminosilicate units.

The geopolymer is initially a castable fiber-free composition brought to cast at the corresponding position of a stopper 15, 16 within the tube body 13, and hardens there. The hardened stopper 15, 16 is permeable to gas. In this way, pressure compensation between the interior space 14, which is delimited by the stoppers 15, 16, of the tube body 13 and the external environment is able to be performed.

Each stopper 15, 16 is arranged at a distance as to the left or to the right of the end face 18 of the roller body 13. The external end portions 19, 20 of the roller body 13 are hollow. The air located therein forms an insulating layer. The end portions 19, 20 have coupling components 21 for transferring the drive energy to the rotation of the furnace rollers 3.

The stoppers 15, 16 are arranged inside the tube body 13 in the length portion 8 or 9 which extends through the side walls 2.

The furnace roller 3 passes through the side wall 2 in each case by way of the end-side length portion 8, 9 inside which the stopper 15, 16 is located. Accordingly, the stopper 15, 16 is arranged at the transition of the furnace chamber 4 to the side wall 2 of the roller furnace 1.

A stopper 15, 16 has a length L_{S} and a roller body 13 has an inner diameter Dᵢ, wherein the ratio of the inner diameter Dᵢ to the length L_{S} of the stopper 15, 16 is between 4:1 and 2:1. The ratio of the inner diameter Dᵢ to the length L_{S} of the stopper 15, 16 is between 3.25:1 and 2.25:1. In the case of an inner diameter Dᵢ of the tube body 13 of 65 mm, the stopper 15, 16 has a corresponding caliber with an outer diameter of 65 mm and has a length L_{S} of 20.0 mm to 25.0 mm.

The furnace roller 3 according to the present disclosure is distinguished by better insulation properties and a longer service life. The thermal shock resistance is increased. Overall, a roller furnace 1 equipped with furnace rollers 3 according to the present disclosure is improved in terms of operation and energy and is distinguished by high plant availability with reduced operating costs.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-11. (canceled)

12. A furnace roller, comprising:
a roller body, wherein the roller body comprises an interior space and end-side length portions; and
a stopper in each of the end-side length portions, wherein the stopper comprises a geopolymer.

13. The furnace roller according to claim 12, wherein the geopolymer is an alkali-activated aluminosilicate.

14. The furnace roller according to claim 12, wherein the roller body comprises an inner diameter and the stopper comprises a length, and a ratio of the inner diameter to the length ranges from 4:1 to 2:1.

15. The furnace roller according to claim 14, wherein the ratio of the inner diameter of the roller body to the length of the stopper ranges from 3.25:1 to 2.25:1.

16. The furnace roller according to claim 12, wherein the stopper is offset from an end face of the roller body.

17. The furnace roller according to claim 12, wherein the stopper is permeable to a gas.

18. The furnace roller according to claim 12, wherein the roller body comprises a ceramic material.

19. The furnace roller according to claim 12, wherein the roller body comprises an outer coating.

20. The furnace roller according to claim 12, wherein the roller body comprises a first material, the stopper comprises a second material, and the first material and the second material able to be classified in a same category of waste.

21. A roller furnace, comprising:
a furnace chamber;
side walls, wherein the side walls delimit the furnace chamber; and
a furnace roller comprising a roller body and a stopper, wherein the roller body comprises an interior space and end-side length portions, and the stopper is in each of the end-side length portions, and each of the end-side length portions are configured to be guided by the side walls.

22. The roller furnace according to claim 21, wherein the stopper is at a transition of the furnace chamber to a sidewall of the side walls.

23. The furnace roller according to claim 12, wherein the roller body comprises a hollow cylinder.

24. The furnace roller according to claim 12, wherein the roller body comprises a sheath.
